(19) United States
(12) Patent Application Publication
(10) Pub. No.: US 2016/0282380 A1
(43) Pub. Date: Sep. 29, 2016

(54) ANALYTICAL DEVICE

(71) Applicant: SHIMADZU CORPORATION, Kyoto-shi, Kyoto (JP)

(72) Inventor: Hajime BUNGO, Kyoto-shi (JP)

(73) Assignee: SHIMADZU CORPORATION, Kyoto-shi, Kyoto (JP)

(21) Appl. No.: 15/033,958

(22) PCT Filed: Jan. 16, 2014
(86) PCT No.: PCT/JP2014/050641

§ 371 Date: May 3, 2016

(51) Int. Cl. G01N 35/10; G01N 30/16

(52) U.S. Cl. CPC G01N 35/1011; G01N 30/16

(57) ABSTRACT

A tip end portion of a needle (2) is to be captured by a camera (6) that moves together with the needle (2). Therefore, even if the needle (2) is moved at the time of insertion of the tip end portion of the needle (2) into a sample container (1), the tip end portion of the needle (2) may be constantly captured, and thus an abnormal state regarding operation of the needle (2), which moves over a wide range, may be easily checked.

### TECHNICAL FIELD

The invention relates to an analytical device for inserting a needle into a sample container, taking in a sample from the tip end portion of the needle, and performing analysis.

### BACKGROUND ART

Some analytical devices are capable of automatically performing analysis with the aim of reducing burden on users and of efficiently using night-time hours, for example. This type of analytical device is capable of automatically performing continuous analysis of samples by repeating operations of inserting a needle into one of a plurality of sample containers, taking in a sample in the sample container from the tip end portion of the needle, and supplying the sample to an analytical section.

A liquid chromatograph, which is an example of the analytical device as described above, is provided with a rack where several tens to hundreds of sample containers may be set, for example, and the needle is sequentially inserted into each of the sample containers on the rack. Specifically, the needle is capable of moving in a horizontal direction and in a vertical direction, and an operation of horizontally moving the needle to above a sample container, inserting the needle into the sample container by moving the needle vertically downward, and moving the needle vertically upward after the sample has been taken in is repeated.

When the needle is moved, due to an error in the position accuracy or the like, the position of the needle may be shifted in the horizontal direction with respect to each sample container, or the needle may not be inserted sufficiently deep into the sample container. The device may break down in such cases, and thus the operation of the device is made possible to be stopped as necessary by detecting an abnormal state by using a predetermined sensor.

For example, such detection of an abnormal state may be performed by detecting, using a photo interrupter, an encoder or the like, the operation state of a motor for moving the needle. However, in many cases, it is difficult to check the details of an abnormal state merely by detecting the operation state of the motor. For example, in a case where an abnormal state occurred at the time of moving the needle in the vertical direction, it is difficult to determine, merely by detecting the operation state of the motor, whether the abnormal state occurred at the time of insertion of the needle into a sample container or at the time of insertion of the needle into another part (such as an injection port or a cleaning port).

Also, if a service man is able to visually check the moment of occurrence of an abnormal state, the cause may be immediately identified, but usually, the service man checks the error code in the log after several days have passed. Therefore, it is difficult to immediately identify the cause of an abnormal state, and it may take a long time to prepare to cope with, or to solve the situation.

It is conceivable to perform capturing by a camera in order to identify the process or cause of occurrence of an abnormal state (for example, see Patent Document 1). Patent Document 1 discloses a configuration where a video captured by a camera is transmitted to a terminal connected to a network.

### PRIOR ART DOCUMENTS

### Patent Documents

JP 2010-25726 A

### SUMMARY OF THE INVENTION

### Problems to be Solved by the Invention

However, even with a configuration where a camera is provided to an analytical device, it is not easy to check an abnormal state regarding operation of a needle that moves over a wide range. That is, since the needle moves over a wide range in the horizontal direction and the vertical direction, if the camera is fixed at a position where the entire movement range of the needle may be captured, a subtle movement of the needle becomes hard to grasp. Also, if capturing is performed from a fixed position, since the needle moves in an image according to the timing of capturing, the position of the needle in an image is hard to check.

The present invention has been made in view of the circumstances described above, and has its aim to provide an analytical device allowing an abnormal state regarding operation of a needle to be easily checked.

### Means for Solving the Problems

An analytical device of the present invention is the analytical device includes a needle, a needle movement mechanism and a camera. The needle is for taking in a sample in a sample container from a tip end portion. The needle movement mechanism is for moving the needle, and for inserting the tip end portion of the needle into the sample container. The camera is for moving together with the needle, and for capturing the tip end portion of the needle.

According to such a configuration, the tip end portion of the needle may be captured by the camera that moves together with the needle. Therefore, even if the needle is moved at the time of insertion of the tip end portion of the needle into the sample container, the tip end portion of the needle may be constantly captured, and thus an abnormal state regarding operation of the needle, which moves over a wide range, may be easily checked.

That is, by constantly capturing the tip end portion of the needle instead of capturing the entire movement range of the needle, even a subtle movement of the needle may be suitably checked. Also, since the needle is constantly at the same position in captured images, the position of the needle in an image is easily checked, and the burden on a service man checking the image may be reduced.

The analytical device may further include a capturing control section for automatically performing capturing by the camera during movement of the needle.

According to such a configuration, capturing by the camera may be automatically performed, and thus even if a user is not present during automatic analysis, the image of the tip end portion of the needle may be reliably captured, and an abnormal state regarding operation of the needle may be checked retrospectively.

It should be noted that, by performing capturing during movement of the needle when there is a possibility of occurrence of an abnormal state, useless capturing at the time when there is no possibility of occurrence of an abnormal state may be prevented from being performed. Since the time of movement of the needle during an analysis is relatively short, by performing capturing only during movement of the needle, the burden on a service man checking images may be greatly reduced.

The analytical device may further include an abnormality detection section for detecting an abnormal state of the needle movement mechanism. In this case, the capturing control section preferably performs capturing by the camera in a case where the abnormal state is detected by the abnormality detection section.

According to such a configuration, in a case where an abnormal state is detected by the abnormality detection section, the tip end portion of the needle at the time is captured by the camera, and thus an abnormal state regarding operation of the needle may be more reliably checked. Since an image of the periphery of the needle is also captured at this time, the position where the abnormal state occurred may also be easily identified.

The capturing control section preferably performs capturing by the camera in synchronization with movement operation of the needle.

According to such a configuration, capturing may be performed in synchronization with movement operation of the needle at a timing when there is a high possibility of occurrence of an abnormal state. If, for example, capturing is performed in synchronization with an operation of inserting the tip end portion of the needle into the sample container, based on a control program at the time of movement of the needle, capturing may be performed at a timing when an abnormal state is likely to occur.

Also, if capturing is continuously performed by the camera, during movement of the needle, in synchronization with the movement operation of the needle, an abnormal state during movement of the needle may be checked in greater detail. Also, in the case where, even if no abnormal state is detected in the analytical device, an abnormal state, such as when a peak of a sample component cannot be found, is discovered at the time of analyzing the analysis result, the cause of occurrence of the abnormal state may be easily identified based on the captured image.

The analytical device may further include an image output control section for outputting an image captured by the camera in association with a capturing time.

According to such a configuration, since not only the image captured by the camera but also the capturing time may be output in association, the cause of occurrence of an abnormal state may be easily identified based on the image and the capturing time which have been output.

### Effects of the Invention

According to the present invention, a tip end portion of a needle can be constantly captured even if there is movement of the needle, and an abnormal state regarding operation of the needle may be easily checked.

### BRIEF DESCRIPTION OF THE DRAWINGS

FIG. 1 is a schematic diagram showing an example configuration of an analytical device according to a first embodiment of the present invention;

FIG. 2 is a block diagram showing an example configuration of a control device;

FIG. 3 is a flow chart showing an example of a process performed at the time of automatic analysis by the control device;

FIG. 4 is a block diagram showing an example configuration of a control device of an analytical device according to a second embodiment of the present invention;

FIG. 5 is a flow chart showing an example of a process performed at the time of automatic analysis by the control device according to the second embodiment; and

FIG. 6 is a flow chart showing an example of a process performed at the time of automatic analysis by a control device according to a third embodiment of the present invention.

### MODE FOR CARRYING OUT THE INVENTION

### First Embodiment

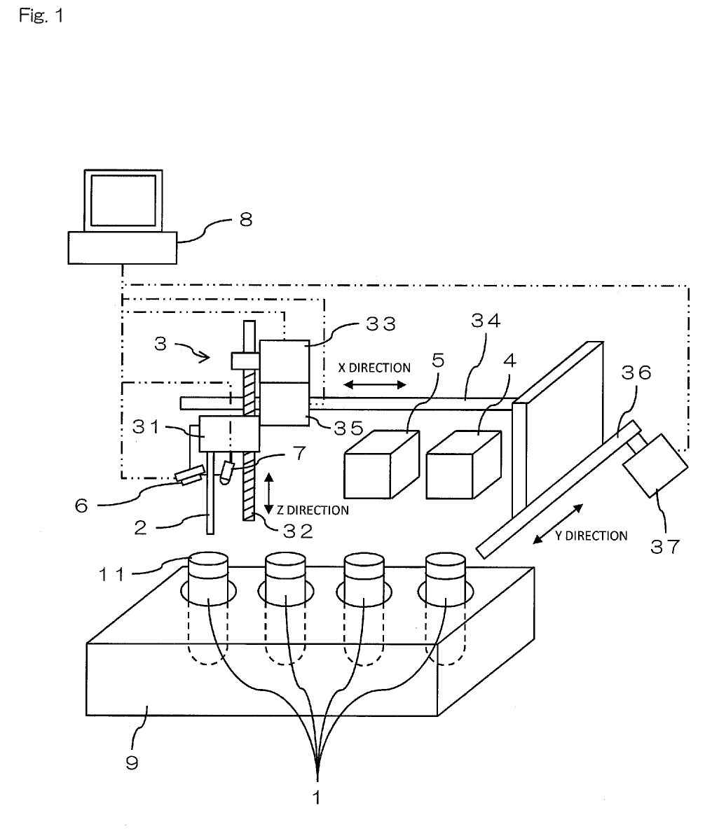

FIG. 1 is a schematic diagram showing an example configuration of an analytical device according to a first embodiment of the present invention. The analytical device according to the present embodiment is configured from a liquid chromatograph, for example, and is capable of analyzing samples by supplying the samples from a plurality of sample containers 1 to an analytical section (not shown). The analytical device includes a needle 2, a needle movement mechanism 3, an injection port 4, a cleaning port 5, a camera 6, a light source 7, a control device 8, and the like.

The sample container 1 is a so-called vial, and its upper opening is closed by a cap 11 in a state where a sample is contained inside. The cap 11 is made of rubber, for example, and the needle 2 may be inserted into the sample container 1 by piercing the cap 11 with the needle 2. In the present embodiment, the sample containers 1 may be held by a rack 9 while being arranged next to one another.

The needle 2 is a long thin tubular member that extends linearly. By driving a pump (not shown) in a state where the needle 2 is inserted in the sample container 1, the sample inside the sample container 1 may be taken in from a tip end portion of the needle 2. The needle 2 is held by the needle movement mechanism 3, and is capable of moving in the horizontal direction and the vertical direction by being driven by the needle movement mechanism 3.

The needle movement mechanism 3 includes a needle holding member 31, a Z-axis member 32, a Z-axis motor 33, an X-axis member 34, an X-axis motor 35, a Y-axis member 36, and Y-axis motor 37, for example. The needle 2 is held by the needle holding member 31 in a manner extending straight in the vertical direction.

The Z-axis member 32 and the Z-axis motor 33 configure a Z-direction movement mechanism for moving the needle 2 held by the needle holding member 31 in the vertical direction (Z direction). The X-axis member 34 and the X-axis motor 35 configure an X-direction movement mechanism for moving the needle 2 held by the needle holding member 31 in the horizontal direction (X direction). The Y-axis member 36 and the Y-axis motor 37 configured a Y-direction movement mechanism for moving the needle 2 held by the needle holding member 31 in the horizontal direction (Y direction) that is perpendicular to the X direction.

The Z-axis member 32 is a shaft member extending straight in the Z direction, and a thread is formed on the outer circumferential surface of the shaft member, for example. The needle holding member 31 includes a through hole where a groove corresponding to the thread on the Z-axis member 32 is formed, and the needle holding member 31 is attached with the Z-axis member 32 screwed in the through hole.

Therefore, when the Z-axis member 32 is rotated, the needle holding member 31 is moved in the Z direction with respect to the Z-axis member 32. Accordingly, by rotating the Z-axis member 32, the needle held by the needle holding member 31 may be moved in the Z direction. The Z-axis member 32 may be rotated by being driven by the Z-axis motor 33 such as a stepping motor, for example.

The X-axis member 34 is configured from a gear shaft that engages with a gear attached to a rotation shaft of the X-axis motor 35, for example. The X-axis motor 35 is integrally held with the Z-axis motor 33, and the Z-axis motor 33, the Z-axis member 32, the needle holding member 31, and the needle 2 may be integrally moved in the X direction by driving the X-axis motor 35.

Furthermore, the Y-axis member 36 is configured from a belt that is wrapped around a rotation shaft of the Y-axis motor 37, for example. The X-axis member 34 is coupled to the Y-axis member 36, and by driving the Y-axis motor 37, the X-axis member 34 may be moved in the Y direction through the Y-axis member 36, and the X-axis motor 35, the Z-axis motor 33, the Z-axis member 32, the needle holding member 31, and the needle 2, which are coupled to the X-axis member 34, may thereby be integrally moved in the Y direction.

As described above, when the Z-axis motor 33, the X-axis motor 35, and the Y-axis motor 37 are appropriately driven, the needle movement mechanism 3 may move the needle 2 to any position along the vertical direction and the horizontal directions. By moving the needle 2 vertically downward after horizontally moving the needle 2 to above the sample container 1, the tip end portion of the needle 2 may be inserted into the sample container 1. Additionally, the needle movement mechanism 3 may adopt various other structures without being limited to the structure as described above that uses the screws, the gear and the belt so long as it is capable of moving the needle 2.

At the time of analysis, the sample in the sample container 1 is taken in by driving a pump (not shown) in a state where the tip end portion of the needle 2 is inserted in the sample container 1, as described above, and then the needle 2 is moved vertically upward and is retracted from the sample container 1. Then, the needle 2 is horizontally moved to above the injection port 4 and is moved vertically downward to be inserted into the injection port 4, and the sample may be supplied to the analytical section from the injection port 4 by driving of the pump.

After the sample is injected, the needle 2 is retracted from the injection port 4 by being moved vertically upward, and is horizontally moved to above the cleaning port 5. Then, the needle 2 is inserted into the cleaning port 5 by being moved vertically downward, and the needle 2 is cleaned in the cleaning port 5. The series of operations of the needle 2 as described above is a sample injection operation for injecting the sample in the sample container 1 into the injection port 4, and by repeating the same operations for each of the sample containers 1, continuous analysis of samples may be automatically performed.

In the present embodiment, the camera 6 and the light source 7 are held by the needle holding member 31. The camera 6 is a miniature camera such as a CCD (Charge Coupled Device) camera, and is attached obliquely above the tip end portion of the needle 2 such that the focus is at the tip end portion of the needle 2. Also, the light source 7 is attached obliquely above the tip end portion of the needle 2 in such a way as to be able to illuminate the tip end portion of the needle 2 from a different angle from the camera 6. An image of the tip end portion of the needle 2 may thereby be captured by the camera 6 while the tip end portion of the needle 2 is being illuminated by the light source 7. Additionally, if the periphery of the tip end portion of the needle 2 is sufficiently lit, the light source 7 may be omitted.

The camera 6 is capable of capturing a predetermined capturing area (for example, several square centimeters) as a still image or a moving image, and a captured image is input to the control device 8. Since the camera 6 and the light source 7 are attached to the needle holding member 31, they can move together with the needle 2. Therefore, even if the needle 2 is moved at the time of insertion of the tip end portion of the needle 2 into the sample container 1, the tip end portion of the needle 2 may be constantly captured. Accordingly, by appropriately performing capturing by the camera 6 during movement of the needle 2, an abnormal state regarding operation of the needle 2, which moves over a wide range, may be easily checked.

That is, by constantly capturing the tip end portion of the needle 2 instead of capturing the entire movement range of the needle 2, even a subtle movement of the needle 2 may be suitably checked. Also, since the needle 2 is constantly at the same position in captured images, the position of the needle 2 in an image is easily checked, and the burden on a service man checking the image may be reduced. Additionally, if a microphone (not shown) is attached to the needle holding member 31, an abnormal state regarding operation of the needle 2 may be checked using not only the image captured by the camera 6 but also an abnormal sound picked up by the microphone.

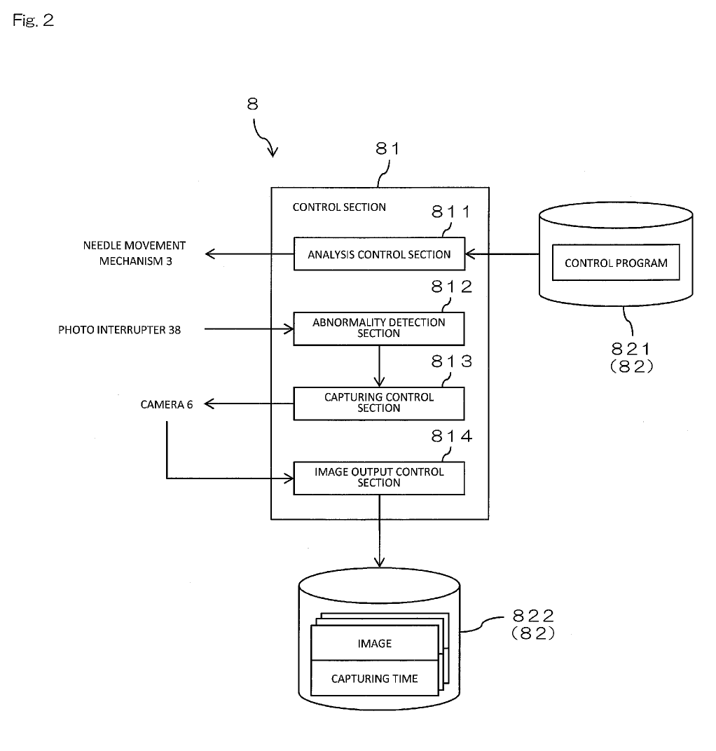

FIG. 2 is a block diagram showing an example configuration of the control device 8. The control device 8 controls operation of the needle movement mechanism 3 (the Z-axis motor 33, the X-axis motor 35, and the Y-axis motor 37), the camera 6, the light source 7, and the like. The control device 8 may be embedded in the analytical device, or may be configured from an external appliance such as a personal computer.

The control device 8 includes a control section 81 and a storage section 82. The control section 81 includes a CPU (Central Processing Unit), for example, and controls operation of the analytical device. The control section 81 functions as an analysis control section 811, an abnormality detection section 812, a capturing control section 813, an image output control section 814 and the like by the CPU executing programs.

The storage section 82 may be configured from a ROM (Read Only Memory), a RAM (Random Access Memory), a hard disk, and the like, for example. The storage section 82 is assigned with a control program storage section 821 for storing control programs, and an image storage section 822 for storing images captured by the camera 6.

The analysis control section 811 analyzes the sample in each sample container 1 by driving the Z-axis motor 33, the X-axis motor 35, and the Y-axis motor 37 of the needle movement mechanism 3, and controlling operation of each section (such as a heater or a detector) of the analytical section, based on the control programs stored in the control program storage section 821. In the present embodiment, analysis conditions for each sample may be set in advance as a method file, and by executing an analysis schedule in which the execution order of the method files is set, continuous analysis of the samples may be automatically performed.

The abnormality detection section 812 detects an abnormal state of the needle movement mechanism 3. In the present embodiment, the needle movement mechanism 3 is provided with a photo interrupter 38. The photo interrupter 38 includes a light emitting section and a light receiving section (neither is shown), and whether the needle 2 is normally moving or not may be determined by detecting by the light receiving section whether light from the light emitting section is blocked by the movement of the needle holding member 31 or not. Additionally, an abnormal state of the needle movement mechanism 3 may be detected by various other sensors such as an encoder without being limited to the photo interrupter 38.

The capturing control section 813 controls capturing by the camera 6. By transmitting a capturing instruction from the capturing control section 813 to the camera 6, the tip end portion of the needle 2 may be captured by the camera 6. In the present embodiment, the capturing control section 813 controls capturing by the camera 6 based on a detection result from the abnormality detection section 812.

Specifically, when an abnormal state is detected by the abnormality detection section 812, a capturing instruction is transmitted to the camera 6 such that capturing by the camera 6 is performed at the timing of detection or within a predetermined period of time from the timing. At this time, the light source 7 is desirably also operated for the predetermined time so that the tip end portion of the needle 2 may be illuminated at least during capturing by the camera 6.

The image output control section 814 outputs an image captured by the camera 6 in association with capturing time. The capturing time may include, in addition to the time of capturing, other pieces of information such as the date of capturing. In the present embodiment, the image and the capturing time output from the image output control section 814 are stored in the image storage section 822 provided to the control device 8, but this configuration is not restrictive, and the image and the capturing time may be stored in a storage section that is provided separately from the control device 8, or may be transmitted to another device over a network or the like.

The image storage section 822 is capable of storing a plurality of images, and any image stored in the image storage section 822 may be read and displayed on a display section (not shown). At this time, since the capturing time is stored in association with the image as a timestamp, when the image was captured may be easily checked. By checking the image and the capturing time stored in the image storage section 822 in the above manner, the cause of occurrence of an abnormal state may be easily identified.

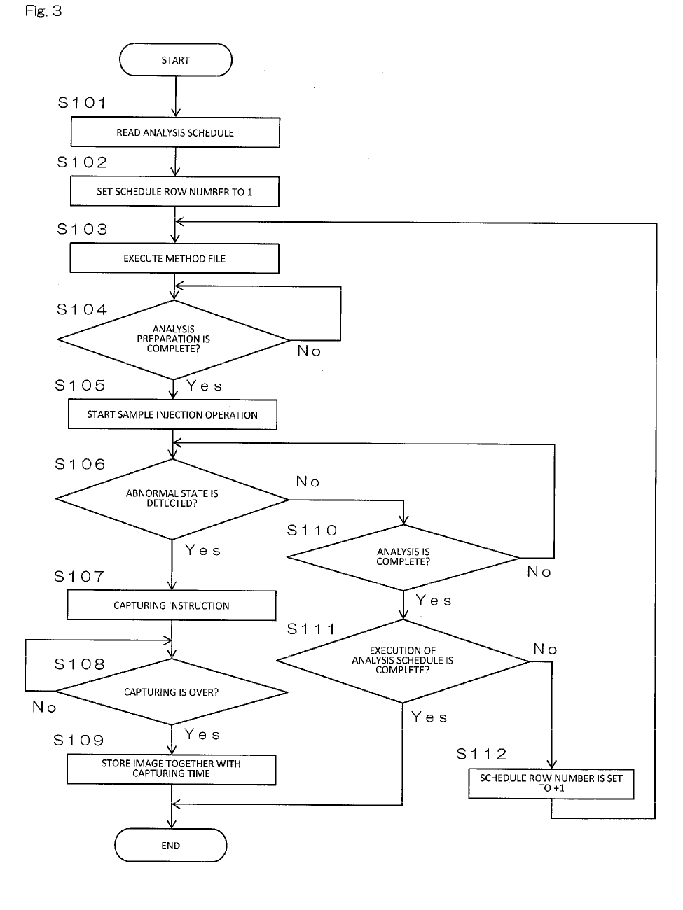

FIG. 3 is a flow chart showing an example of a process performed at the time of automatic analysis by the control device 8. In the present embodiment, automatic analysis of samples contained in the sample containers 1 may be performed based on an analysis schedule in which a plurality of method files are arranged in a plurality of rows according to the execution order.

At the time of automatic analysis, first, the analysis schedule is read from the storage section 82 (step S101), and the row number of the method file to be executed according to the analysis schedule (schedule row number) is set to “1” (step S102). Then, when the method file of the schedule row number which has been set is executed (step S103), analysis preparations such as detection wavelength setting, temperature adjustment, liquid delivery and the like are performed according to the analysis conditions set in the method file.

When the analysis preparations are complete (Yes in step S104), a sample injection operation by the needle movement mechanism 3 is started (step S105). The sample injection operation includes a series of operations of the needle 2 for supplying the sample in a sample container 1 to the analytical section, such as insertion of the needle 2 into the sample container 1, movement of the needle 2 to the injection port 4, insertion of the needle 2 into the injection port 4, movement of the needle 2 to the cleaning port 5, and insertion of the needle 2 into the cleaning port 5.

In the present embodiment, whether an abnormal state of the needle movement mechanism 3 is detected or not is monitored by the photo interrupter 38 during the sample injection operation as described above (step S106). Then, if an abnormal state of the needle movement mechanism 3 is detected during the sample injection operation (Yes in step S106), a capturing instruction is transmitted to the camera 6 (step S107). Capturing by the camera 6 may thereby be automatically performed during movement of the needle 2. At this time, the camera 6 may capture a still image, or may capture a moving image for a specific period of time.

Then, when capturing by the camera 6 is over (Yes in step S108), the captured image is stored in the image storage section 822 together with the capturing time (step S109). In the present case, the display section (not shown) of the analytical device is notified of the abnormal state, and the analysis schedule is suspended.

On the other hand, in the case where no abnormal state is detected (No in step S106), and the analysis is completed (Yes in step S110), whether all of the analysis schedule has been executed is determined (step S111). In the case where not all of the analysis schedule has been executed (No in step S111), +1 is set with respect to the schedule row number (step S112), and the processes in step S103 and later steps are performed to thereby perform analysis of the next sample.

In this manner, analysis of samples in the sample containers 1 is sequentially performed while monitoring whether or not an abnormal state of the needle movement mechanism 3 is detected (step S106). Then, when all of the analysis schedule has been executed (Yes in step S111), the process of the automatic analysis is ended.

In the present embodiment, capturing by the camera 6 may be automatically performed, and thus even if a user is not present during automatic analysis, the image of the tip end portion of the needle 2 may be reliably captured, and an abnormal state regarding operation of the needle 2 may be checked retrospectively.

It should be noted that, by performing capturing during movement of the needle 2 when there is a possibility of occurrence of an abnormal state, useless capturing at the time when there is no possibility of occurrence of an abnormal state may be prevented from being performed. Since the time of movement of the needle 2 during an analysis is relatively short, by performing capturing only during movement of the needle 2, the burden on a service man checking images may be greatly reduced. Such an effect is even more significant in a case of capturing a moving image by the camera 6 or of capturing a still image by the camera 6 every specific period of time.

### Second Embodiment

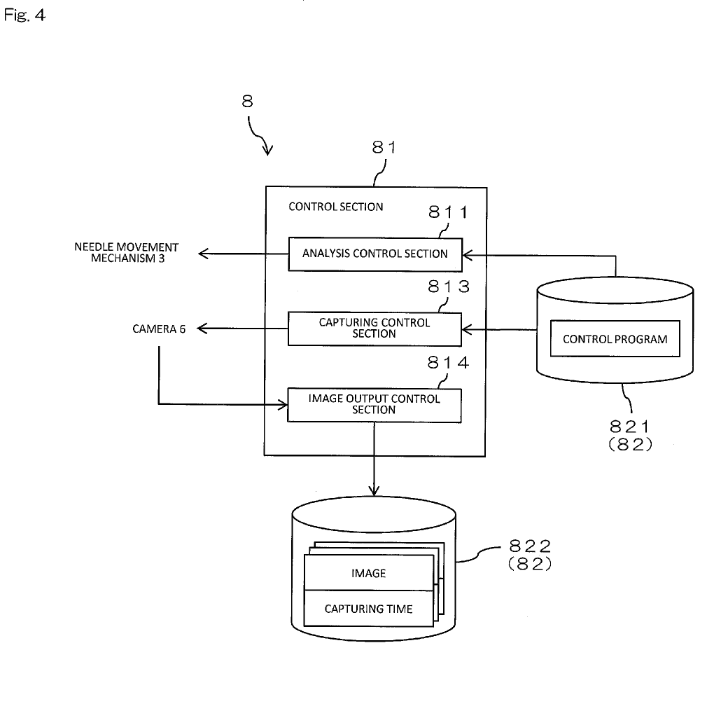

FIG. 4 is a block diagram showing an example configuration of a control device 8 of an analytical device according to a second embodiment of the present invention. In the present embodiment, only the configuration of a control section 81 of the control device 8 is different from that in the first embodiment, and other configurations are the same as in the first embodiment, and thus the same configurations are denoted by the same reference signs in the drawing, and detailed description thereof is omitted.

The control section 81 according to the present embodiment functions as the analysis control section 811, the capturing control section 813, the image output control section 814, and the like. As in the first embodiment, the analysis control section 811 analyzes the sample in each sample container 1 by driving the Z-axis motor 33, the X-axis motor 35, and the Y-axis motor 37 of the needle movement mechanism 3, and controlling operation of each section (such as a heater or a detector) of the analytical section, based on the control programs stored in the control program storage section 821.

As in the first embodiment, the capturing control section 813 controls capturing by the camera 6, but instead of controlling capturing by the camera 6 based on a detection result from the abnormality detection section 812 as in the first embodiment, the capturing control section 813 controls capturing by the camera 6 based on the control programs stored in the control program storage section 821.

Specifically, timings during movement of the needle 2 when there is a possibility of occurrence of an abnormal state (especially, the timing of the needle 2 moving in the vertical direction), such as insertion of the needle 2 into the sample container 1, insertion of the needle 2 into the injection port 4, and insertion of the needle 2 into the cleaning port 5, may be identified based on the control programs. In the present embodiment, a capturing instruction is transmitted to the camera 6 such that capturing by the camera 6 is performed at such a timing or within a predetermined period of time from the timing. At this time, the light source 7 is desirably also operated for the predetermined time so that the tip end portion of the needle 2 may be illuminated at least during capturing by the camera 6.

As in the first embodiment, the image output control section 814 outputs an image captured by the camera 6 in association with the capturing time, and the image and the capturing time which have been output are stored in the image storage section 822. Additionally, such a configuration is not restrictive, and the image and the capturing time output from the image output control section 814 may be stored in a storage section that is provided separately from the control device 8, or may be transmitted to another device.

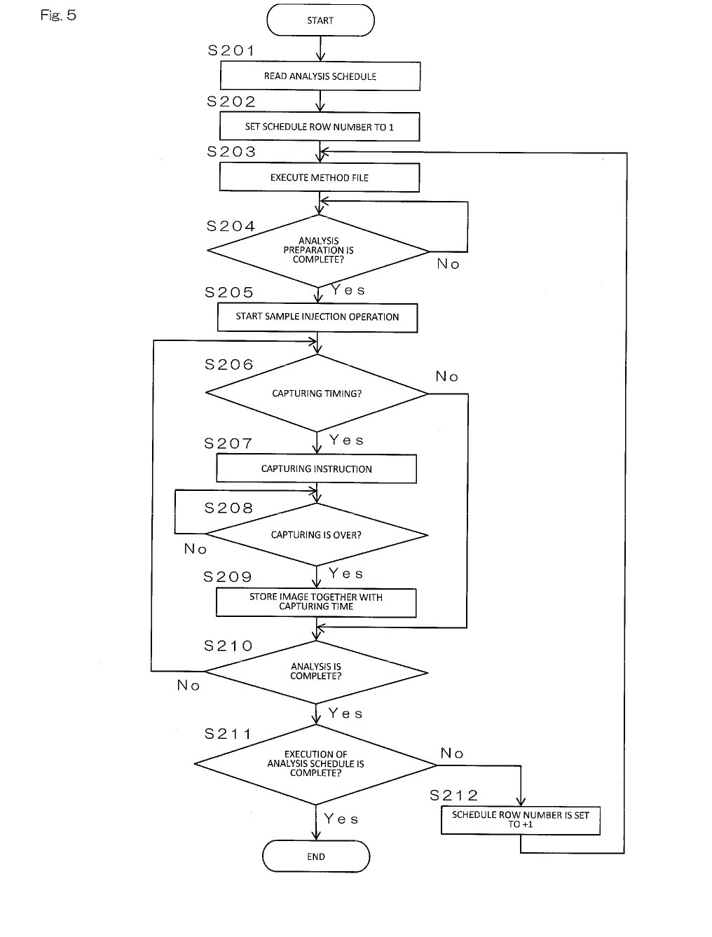

FIG. 5 is a flow chart showing an example of a process performed at the time of automatic analysis by the control device 8 according to the second embodiment. In the present embodiment, as in the first embodiment, automatic analysis may be performed for samples in the sample containers 1 based on an analysis schedule, and processes in steps S201 to S205 are the same as the processes in steps S101 to S105 in FIG. 3.

During sample injection operation, capturing by the camera 6 is performed in synchronization with the movement operation of the needle 2 at a timing specified in advance by the control program as a timing when there is a possible occurrence of an abnormal state (capturing timing). That is, when a capturing timing set in advance is reached (Yes in step S206), a capturing instruction is transmitted to the camera 6 (step S207), and capturing by the camera 6 is automatically performed during movement of the needle 2. At this time, the camera 6 may capture a still image, or may capture a moving image for a specific period of time.

Then, when capturing by the camera 6 is over (Yes in step S208), the captured image is stored in the image storage section 822 together with the capturing time (step S209). During analysis, the processes in steps S207 to S209 are performed every time a capturing timing is reached, and when the analysis is over (Yes in step S210), whether all of the analysis schedule has been executed is determined (step S211). In the case where not all of the analysis schedule has been executed (No in step S211), +1 is set with respect to the schedule row number (step S212), and the processes in step S203 and later steps are performed to thereby perform analysis of the next sample.

In this manner, analysis of samples in the sample containers 1 is sequentially performed while determining whether the capturing timing is reached or not (step S206). Then, when all of the analysis schedule has been executed (Yes in step S211), the process of the automatic analysis is ended. Additionally, the image captured by the camera 6 and the capturing time may be output at another timing such as when all of the analysis schedule has been executed.

In the present embodiment, capturing by the camera 6 may be automatically performed, and thus even if a user is not present during automatic analysis, the image of the tip end portion of the needle 2 may be reliably captured, and an abnormal state regarding operation of the needle 2 may be checked retrospectively.

It should be noted that capturing may be performed in synchronization with the movement operation of the needle 2 at a timing when there is a high possibility of occurrence of an abnormal state (i.e. the capturing timing). If, as in the present embodiment, capturing is performed in synchronization with an operation of inserting the tip end portion of the needle 2 into the sample container 1, based on a control program at the time of movement of the needle 2, capturing may be performed at a timing when an abnormal state is likely to occur.

### Third Embodiment

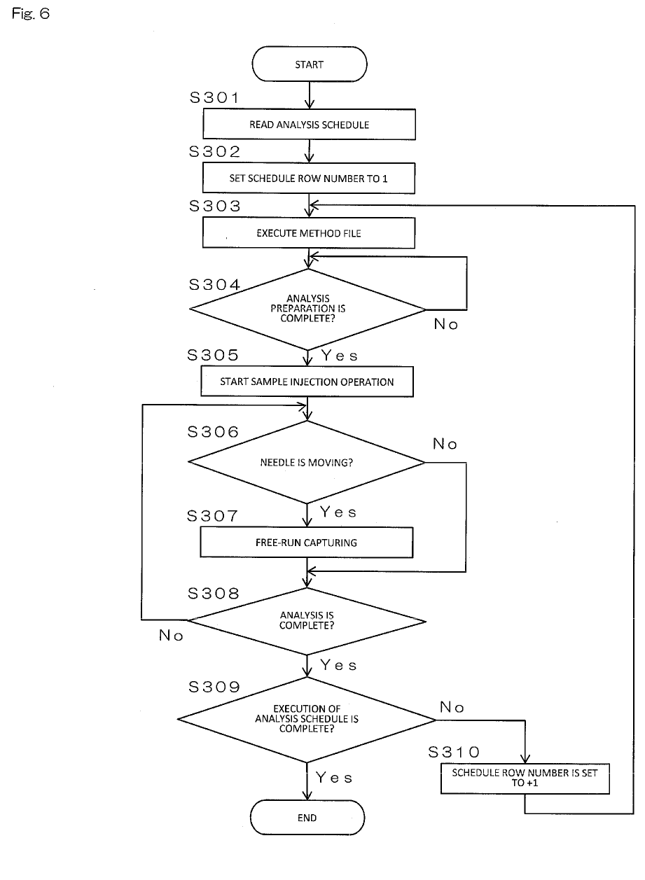

FIG. 6 is a flow chart showing an example of a process performed at the time of automatic analysis by the control device 8 according to a third embodiment of the present invention. In the present embodiment, only the mode of processing by the control device 8 is different from that in the second embodiment, and the configuration of the control device 8 is the same as that in the second embodiment shown in FIG. 4.

In the present embodiment, the capturing control section 813 continuously performs capturing by the camera 6 (free-run capturing) while the needle 2 is moving in the vertical direction or in the horizontal direction, instead of performing capturing by the camera 6 only at a specific timing as in the second embodiment. In the free-run capturing, still images may be successively captured by the camera 6 during movement of the needle 2 at a specific time interval (for example, a short interval of 0.5 seconds), or a moving image may be continuously captured by the camera 6. At this time, the light source 7 is desirably also continuously operated during movement of the needle 2.

In the present embodiment, as in the second embodiment, automatic analysis may be performed for samples in the sample containers 1 based on an analysis schedule, and processes in steps S301 to S305 are the same as the processes in steps S201 to S205 in FIG. 5.

During sample injection operation, free-run capturing is performed (step S307) when the needle 2 is moving (Yes in step S306). At this time, free-run capturing may be performed in synchronization of the movement operation of the needle 2 by identifying the timing of movement of the needle 2 based on a control program or by detecting movement of the needle 2 by using a sensor or the like. A captured image is stored in the image storage section 822 together with the capturing time.

During analysis, the process in step S307 is performed when the needle 2 is moving, and when the analysis is over (Yes in step S308), whether all of the analysis schedule has been executed is determined (step S309). In the case where not all of the analysis schedule has been executed (No in step S309), +1 is set with respect to the schedule row number (step S310), and the processes in step S303 and later steps are performed to thereby perform analysis of the next sample.

In this manner, analysis of samples in the sample containers 1 is sequentially performed while determining whether the needle 2 is moving or not (step S306). Then, when all of the analysis schedule has been executed (Yes in step S309), the process of the automatic analysis is ended. Additionally, the image captured by the camera 6 and the capturing time may be output at another timing such as when all of the analysis schedule has been executed.

In the present embodiment, capturing by the camera 6 may be automatically performed, and thus even if a user is not present during automatic analysis, the image of the tip end portion of the needle 2 may be reliably captured, and an abnormal state regarding operation of the needle 2 may be checked retrospectively.

It should be noted that capturing may be performed in synchronization with the movement operation of the needle 2 at a timing when there is a high possibility of occurrence of an abnormal state (i.e. during movement of the needle 2). If, as in the present embodiment, capturing is continuously performed by the camera 6, during movement of the needle 2, in synchronization with the movement operation of the needle 2, an abnormal state during movement of the needle 2 may be checked in greater detail. Also, in the case where, even if no abnormal state is detected by the analytical device, an abnormal state, such as when a peak of a sample component cannot be found, is discovered at the time of analyzing the analysis result, the cause of occurrence of the abnormal state may be easily identified based on the captured image.

The embodiments described above describe a case of performing capturing by the camera 6 at the time of automatically performing continuous analysis of samples in the sample containers 1 based on the analysis schedule. However, capturing by the camera 6 may be performed at the time of individually analyzing the samples in the sample containers 1, instead of at the time of continuous analysis.

Furthermore, the configuration for automatically performing capturing by the camera 6 during movement of the needle 2 is not restrictive, and capturing by the camera 6 may also be performed manually. In this case, the capturing control section 813 may transmit a capturing instruction to the camera 6 based on a capturing instruction operation by a user.

Moreover, the embodiments described above describe a liquid chromatograph as an example of the analytical device. However, the present invention may also be applied to other analytical devices such as a gas chromatograph, a bio-clinical device, a mass spectrometer and the like.

### DESCRIPTION OF REFERENCE SIGNS

1 sample container

2 needle

3 needle movement mechanism

4 injection port

5 cleaning port

6 camera

7 light source

8 control device

9 rack

11 cap

31 needle holding member

32 Z-axis member

33 Z-axis motor

34 X-axis member

35 X-axis motor

36 Y-axis member

37 Y-axis motor

38 photo interrupter

81 control section

82 storage section

811 analysis control section

812 abnormality detection section

813 capturing control section

814 image output control section

821 control program storage section

822 image storage section

1. An analytical device comprising:
a needle for taking in a sample in a sample container from a tip end portion;
a needle movement mechanism for moving the needle, and for inserting the tip end portion of the needle into the sample container; and
a camera for moving together with the needle, and for capturing the tip end portion of the needle.

2. The analytical device according to claim 1, further comprising a capturing control section for automatically performing capturing by the camera during movement of the needle.

3. The analytical device according to claim 2, further comprising an abnormality detection section for detecting an abnormal state of the needle movement mechanism,
wherein the capturing control section performs capturing by the camera in a case where the abnormal state is detected by the abnormality detection section.

4. The analytical device according to claim 2, wherein the capturing control section performs capturing by the camera in synchronization with movement operation of the needle.

5. The analytical device according to claim 1, further comprising an image output control section for outputting an image captured by the camera in association with a capturing time.

6. The analytical device according to claim 4, wherein the capturing control section performs capturing by the camera in synchronization with an operation of inserting the tip end portion of the needle into the sample container, based on a control program at a time of movement of the needle.

7. The analytical device according to claim 4, wherein the capturing control section identifies, based on the control program at the time of movement of the needle, a timing of insertion of the needle into the sample container, of insertion of the needle into an injection port, or of insertion of the needle into a cleaning port, and performs capturing by the camera at the timing or within a predetermined period of time from the timing.

8. The analytical device according to claim 4, wherein the capturing control section performs capturing by the camera continuously during movement of the needle, in synchronization with the movement operation of the needle.

9. The analytical device according to claim 8, wherein the capturing control section performs capturing by the camera continuously during movement of the needle in a vertical direction or in a horizontal direction.

10. The analytical device according to claim 8, further comprising a light source, wherein the light source is operated only during capturing by the camera.

11. The analytical device according to claim 10, wherein the light source illuminate the tip end portion of the needle.

12. An analytical device comprising:
a needle for taking in a sample in a sample container from a tip end portion;
a needle movement mechanism for moving the needle, and for inserting the tip end portion of the needle into the sample container; and
a light source for moving together with the needle.
